(19) United States
(12) Patent Application Publication
(10) Pub. No.: US 2017/0277769 A1
(43) Pub. Date: Sep. 28, 2017

(54) TECHNIQUES TO MANAGE TIME-VARYING CLUSTER CONFIGURATION INFORMATION

(71) Applicant: NETAPP, INC., Sunnyvale, CA (US)

(72) Inventors: Shankar Pasupathy, Milpitas, CA (US); Jayanth Kumar M J, Bangalore (IN); Abhishek Varshney, Bangalore (IN); Anusha Sivananainthaperumal, San Jose, CA (US); Vipul Mathur, Bangalore (IN)

(21) Appl. No.: 15/082,979

(22) Filed: Mar. 28, 2016

(51) Int. Cl. G06F 17/30

(52) U.S. Cl. CPC G06F 17/30598; G06F 17/30958; G06F 17/30961

(57) ABSTRACT

A cluster configuration system arranged to manage a graph database for tracking and identifying a time-varying state of a cluster of objects. The graph database may include one or more nodes and one or more associations between the nodes to represent time-varying states of the cluster. Management of the graph database may include creating, maintaining, updating, storing, administrating, querying, and/or presenting one or more elements of the graph database.

### BACKGROUND

A cluster may include one or more objects grouped together to form a scalable cluster. Creating a cluster may enable the objects to pool their resources and distribute work across the cluster, while presenting administrators with a single entity to manage. Clustering may also enables continuous service to end users if individual objects go offline. A configuration or state of a cluster may identify a set of objects included in the cluster and associations between objects in the set. The configuration or state of the cluster at any moment in time may be referred to as a snapshot of the cluster. The configuration of the cluster may change over time, such as when an object goes offline or a new object is added to the cluster.

### BRIEF DESCRIPTION OF THE DRAWINGS

FIG. 1 illustrates an embodiment of a cluster configuration system.

FIG. 2 illustrates an embodiment of an event correlation application of an exemplary cluster configuration system.

FIG. 3 illustrates an embodiment of a snapshot of a cluster in a graph database of an exemplary cluster configuration system.

FIG. 4 illustrates an embodiment of a cluster configuration in an exemplary graph database.

FIG. 5 illustrates an example process flow for maintaining a graph database with an embodiment of an event correlation application.

FIG. 6 illustrates an embodiment of a first process flow for storing a cluster configuration in a graph database.

FIG. 7 illustrates an embodiment of a second process flow for storing a cluster configuration in a graph database.

FIG. 8 illustrates an example process flow for querying a graph data base with an embodiment of an event correlation application.

FIG. 9 illustrates an embodiment of a process flow for tracing associations in a graph database.

FIG. 10 illustrates an embodiment of a first logic flow.

FIG. 11 illustrates an embodiment of a second logic flow.

FIG. 12 illustrates an embodiment of a storage medium.

FIG. 13 illustrates an embodiment of a computing architecture.

FIG. 14 illustrates an embodiment of a communications architecture.

### DETAILED DESCRIPTION

Various embodiments are generally directed to techniques for managing a data base, such as a graph database regarding configurations and relationships in a cluster of one or more objects, for example. Some embodiments are particularly directed to cluster configuration systems arranged to track and identify time-varying configurations and relationship states of a cluster of objects by managing a graph database. Management of the graph database may include creating, maintaining, updating, storing, administrating, querying, and/or presenting one or more elements, such as configuration graphs or snapshots, in the graph database. For instance, the cluster configuration system may receive notifications indicating the configuration of one or more objects in a cluster at different moments in time. In response to a notification, one or more nodes or vertices and/or one or more associations or edges may be created (e.g., a sub graph) and utilized in conjunction with existing nodes and associations (e.g., configuration graph) to represent a snapshot of the cluster and relationships between objects in the cluster in the graph database at the moment in time associated with the notification. Nodes and their associations in the graph database may be utilized to readily retrieve historic views, such as snapshots, and relationships between historic views of the cluster at various points or periods in time.

Challenges facing tracking and identifying time-varying states of a cluster of objects include the ability to efficiently utilize storage space in a database and readily identify relationships between and changes to the states of the cluster. Notifications regarding the state of the cluster may be frequently received. However, the configuration of the cluster may not actually change between each notification. This may result in a large amount of redundant data regarding the state of a cluster being stored in the database. Such limitations can cause inefficient utilization of storage space when tracking the state of a cluster. Efficient storage space utilization relies, at least in part, on the ability to quickly identify relationships between time-varying states of the cluster. To achieve this, a current state of the cluster needs to be quickly and efficiently compared to a previous state of the cluster. This comparison can be time consuming and processor intensive resulting in an inefficient system. Adding further complexity, notifications received regarding the configuration of a cluster may be stateless. These stateless notifications may make it difficult or impossible to quickly identify changes and trace relationships between various configurations of the cluster. Adding further complexity, different objects in the cluster may change at different rates. All of these challenges contribute to inefficient systems with reduced capabilities and poor utilization of database storage space.

Conventional solutions attempt to solve the difficulties associated with tracking and identifying time-varying states of a cluster of objects by requiring manual identification of configuration changes. It is impractical to accurately or efficiently manually identify configuration changes. Also, manual identification relies on large amounts of duplicate data to represent unchanging objects, significantly decreasing the efficiency with which storage space is utilized. Such techniques may entail needless complexity, high costs, and poor efficiency.

To solve these and other problems, various embodiments include an event correlation application to efficiently utilize storage space and readily retrieve historic views of and changes to the configuration of the cluster at a point or period in time. The event correlation application may operate to identify relationships between different states of a cluster to prevent duplicate data from being stored. The relationships between different states of the cluster may also be used to query and trace states and state changes to the cluster of objects. Also to solve these and other problems, the event correlation application may dynamically adjust the granularity of time with which one or more objects in a cluster are tracked.

In one embodiment, the event correlation application may utilize a graph database of nodes and edges regarding configurations of a cluster of one or more objects. For example, the event correlation application may include a notification interface component, an indexing component, and a graph engine. The notification interface component may receive a notification indicating a current configuration of the cluster of one or more objects. The indexing component may compare the current configuration of the cluster with a previous configuration of the cluster that is associated with a previous timestamp node in the graph database. The graph engine may create a current timestamp node based on the received notification and associate the current timestamp node with the previous timestamp node in the graph database based on the comparison of the current and previous configurations of the cluster.

The use of an event correlation application provides several advantages relative to conventional solutions. For example, using an event correlation application may allow time-varying configuration data regarding a cluster of objects to be stored to a graph database using associations between nodes to eliminate the need for redundant data. Preventing redundant data from being stored to a database in this manner may improve the efficiency with which storage space in a database is utilized. Furthermore, the use of associations between nodes may enable the event correlation application to query the graph database to readily identify states of the cluster at a moment in time as well as changes to the cluster over a period of time. This greatly increases the ability to identify and track time-varying configurations of a cluster of objects. This capability may also improve the ability to resolve issues regarding a cluster of objects. For example, changes to the configuration of the cluster may facilitate identifying the cause of a cluster malfunction such as an outage. These advantages can enable a more accurate, reliable, and robust cluster configuration system.

With general reference to notations and nomenclature used herein, portion of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

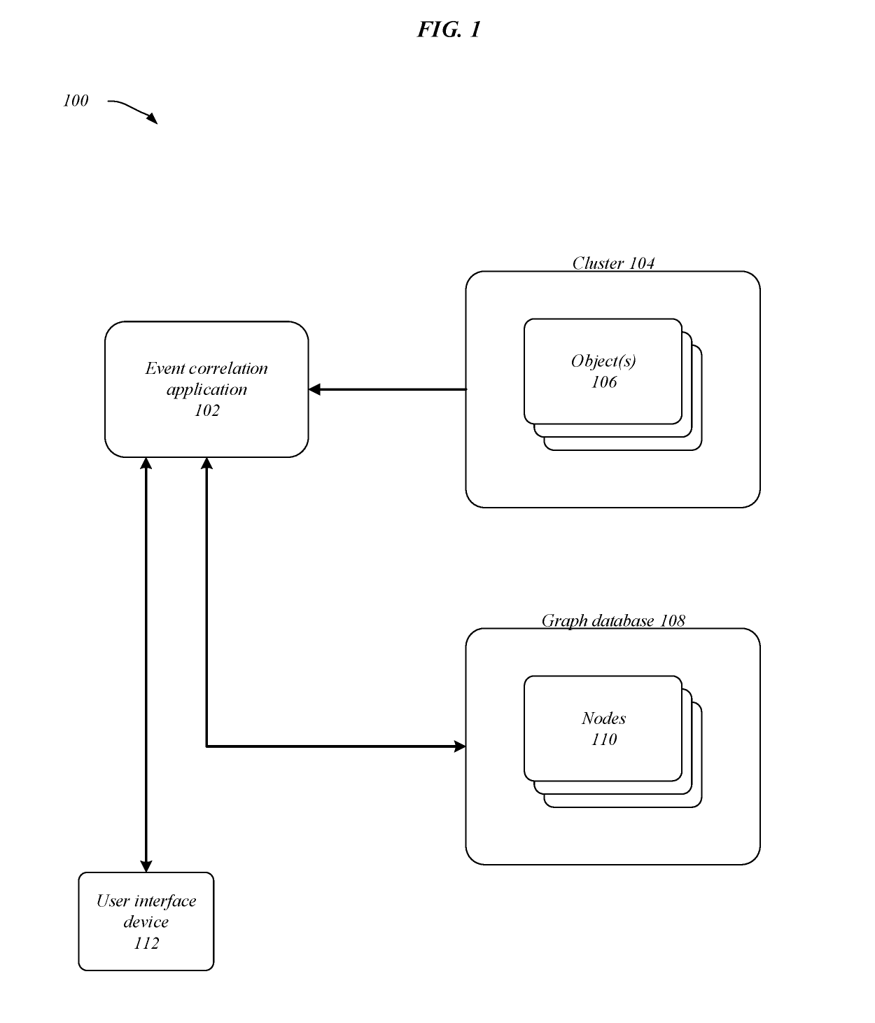

FIG. 1 illustrates one embodiment of a cluster configuration system 100. The cluster configuration system 100 may be used to provide efficient storage and retrieval of information regarding the configuration or state of a cluster of objects at a point or period in time. In some embodiments, the configuration of a cluster may be represented with a graph of interconnected objects. The system 100 may include event correlation application 102, cluster 104, graph database 108, and user interface device 112. The event correlation application 102 may monitor and track the configuration of one or more objects 106 in a cluster 104 via management of graph database 108. One or more nodes 110 or vertices and associations between nodes 110 or edges may be utilized by the event correlation application 102 to represent snapshots in graph database 108, as well as any relationships between nodes or snapshots. In some embodiments, these may be represented as configuration graphs. The structure of the graph database 108 may enable efficient utilization of storage space in graph database 108 and ready retrieval of historic views of and changes to the configuration of the cluster 104 at a point or period in time by user interface device 112 via event correlation application 102. These and other features of the cluster configuration system 100 can improve tracking and identifying time-varying states of one or more clusters of objects. Embodiments are not limited in this context.

The event correlation application 102 may be interposed between cluster 104 and graph database 108. Notifications regarding the state of cluster 104 may be received by event correlation application 102. These notifications may be used by event correlation application 102 to manage graph database 108. Management of the graph database 108 may include creating, maintaining, updating, storing, administrating, querying, and/or presenting one or more elements of the graph database 108 (e.g., snapshots, configuration graphs, etc.). Objects 106 in cluster 104 may be represented in graph database 108 with nodes 110. Associations between the nodes 110 may enable event correlation application 102 to represent time-varying states or configurations of cluster 104 in graph database 108 (e.g., snapshots and their dynamic relationships). In some embodiments, event correlation application 102 may provide manage graph database 108 for a plurality of clusters 104.

Cluster 104 may include a network of objects 106 that interoperate to perform a function or provide a service to one or more clients. In some embodiments the network of objects 106 may include a network-attached storage (NAS), storage area network (SAN), cloud computing or storage pool, and the like. Each object 106 in cluster 104 may represent a piece or collection of hardware or software elements utilized by cluster 104. For instance, cluster 104 may include objects 106 representing one or more disk drives, disk drive aggregates, flash arrays, storage controllers, logical volumes, processors, or the like. In some embodiments, objects 106 may represent virtual components of cluster 104 (e.g. virtual disk drive, virtual processor, etc.). In some embodiments, cluster 104 may include one or more sub-clusters. For instance, a collection of hardware elements (e.g., disk array) may be represented in cluster 104 with a sub-cluster with each disk in the array represented by an object in the sub-cluster. In various embodiments, cluster 104 may refer to a hosted object storage service. In various such embodiments, the hosted object storage service may comprise cloud storage. Cloud storage may be made up of many distributed resources, represented as objects 106, that act as a single resource from the perspective of the one or more clients.

Graph database 108 may include a network of nodes 110 used to store time-varying configuration information regarding one or more clusters. In various embodiments, graph database 108 may include one or more graphs of interconnected objects. In some embodiments, the graph database 108 may function with one or more memories including in-memory, random access memory (RAM), non-volatile memory (NVM), storage class memory (SCM), flash arrays, disk drives and the like. Event correlation application 102 may implement storage resource management (SRM) functions on graph database 108.

The structure of the graph database 108 may enable efficient utilization of storage space in graph database 108 and ready retrieval of historic views of and changes to the configuration of the cluster 104 at a point or period in time. For example, associations between nodes 110 may be used to prevent redundant data regarding the state of an object 106 in cluster 104 from being stored to the graph database 108. In various embodiments, cluster configurations may be represented in graph database 108 as one or more graphs of interconnected objects. In various such embodiments, graphs or objects in graphs may be interconnected with other graphs or objects in other graphs in any manner beneficial for tracking configurations of a cluster. In some embodiments, graph database 108 may be include one or more hierarchical time trees (HTTs).

User interface device 112 may include any computing device that interfaces with event correlation application 102 to enable retrieval historic views of and changes to a configuration of the cluster at a point or period in time. User interface device 112 may include an interface and a display. The interface may be used to receive queries regarding the state of the cluster at a point or period in time. The display may be used to communicate or present historic view and/or changes to the configuration of the cluster to a user. In various embodiments, a graphical user interface (GUI) is used for to receive queries and communicate or present configuration data. In some embodiments, user interface device 112 may be used to control and adjust settings of the event correlation application 102. For example, user interface device 112 may be used to direct event correlation application 102 to manage a new or additional cluster of objects.

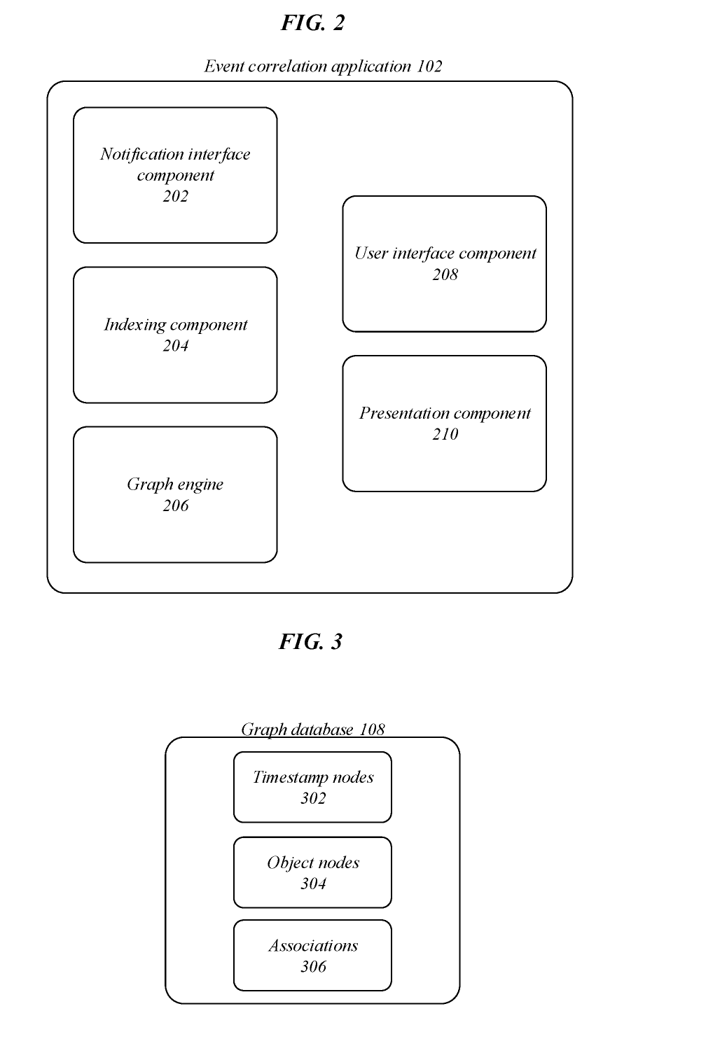

FIG. 2 illustrates an embodiment of the event correlation application 102. The event correlation application 102 may enable cluster configuration system 100 to efficiently track and identify a time-varying state of a cluster of objects such as cluster 104, for example. Components of the event correlation application 102 may interoperate to manage graph database 108. Management of the graph database 108 may include creating, storing, administrating, querying, and/or presenting one or more portions of the graph database 108. Management by event correlation application 102 may result in efficient use of storage space and improved querying of graph database 108. Embodiments are not limited in this context.

As shown in FIG. 2, the event correlation application 102 may include a notification interface component 202, an indexing component 204, a graph engine 206, a user interface component 208, and a presentation component 210. The parts may interoperate to manage graph database 108. In some embodiments, management of graph database 108 may include one or more steps of receiving notifications regarding the state of cluster 104, indexing the received notification, generating nodes in graph database 108, creating associations between nodes in graph database 108, receiving queries regarding the configuration of a cluster of nodes, retrieving requested information from graph database 108, and presenting or communicating information retrieved from graph database 108.

The notification interface component 202 may receive data regarding the state or configuration of a cluster of objects such as cluster 104, for example. The state data regarding the cluster 104 of objects 106 may include a time (e.g. timestamp) to indicate when the data was created or relevant. In some embodiments, the state data may be received as a notification such as an autosupport notification (ASUP), for example. Autosupport notifications may include data associated with the health of a storage server, data associated with any problems detected by a storage server, and additional data. Commonly, ASUPs include a full range of data to facilitate troubleshooting a current or pending problem. For example, ASUPs may include all diagnostic logs available to the storage server. The storage server may be directed to issue an ASUP when an application or system crash is detected, on receipt of a command from the event correlation application 102, or according to other criteria.

In embodiments that the event correlation application 102 manages time-varying configuration information for a plurality of clusters, the notification interface component 202 may identify which cluster the notification is relevant to. The notification interface component then may extract relevant information from the notification to pass to indexing component 204. The relevant information may include the state of one or more objects 106 of cluster 104 at a time and one or more properties of the one or more objects 106 at the time.

Indexing component 204 may use the information received from the notification interface component 202 to compare the received state data regarding the configuration of the cluster 104 to one or more other configurations of the cluster 104. In some embodiments, the other configuration of the cluster 104 with which the received state data is compared to may be based on the time associated with the received state data and a time associated with the other configuration of the cluster 104. For instance, the received state data may be compared with a configuration of the cluster 104 at the closest preceding time associated with a previous configuration of the cluster 104.

This comparison may enable indexing component 204 to identify changes between different states of the cluster 104. For example, the indexing component 204 may identify that the received state data includes additional objects than a previous state of the cluster 104. In another example, the indexing component 204 may identify that the received state data includes fewer or missing objects than a previous state of the cluster 104. In another example, the indexing component 204 may identify that the received state data includes the same objects as a previous state of the cluster 104. In another example, a change in one or more properties of an object may be identified by indexing component 204. In another example, the indexing component 204 may identify a change in one or more relationships or relationship properties between objects. In some embodiments a metadata server/api component may be used as input by the indexing component for its comparison logic.

Node engine 206 may create one or more nodes in graph database 108 in response to the results of the comparison. The graph engine 206 may also create one or more associations between the nodes to map the configuration of the cluster 104. In some embodiments the associations between nodes in the graph database 108 may enable time-varying states of the cluster 104 to be traced. Tracing of the time-varying states may enable ready identification of changes between configurations of the cluster 104. For example, the indexing component 204 may identify the addition of an object to the cluster 104, in response, the graph engine 206 may generate a new node in the graph database 108. The graph engine 206 may then create one or more associations between the new node and other nodes in the graph database 108 to represent the current configuration of the cluster in graph database 108. In some embodiments, the associations enable the event correlation application 102 to prevent duplicate configuration information from being stored to graph database 108. For instance, if an object in the cluster 104 remains unchanged between subsequent notifications regarding configurations, the node in graph database 108 representing the unchanged object may be reused to represent the unchanged object. By reusing the unchanged object greater storage efficiency can be realized.

The user interface component 208 may facilitate communication between external input/output (I/O) devices (e.g. user interface device 112) and the event correlation application 102. This communication may be used to control one or more operational aspects of the event correlation application 102. For instance, the event correlation application 102 may receive a query requesting cluster configuration information at a point or during a period of time via user interface device 112. In some embodiments, object clusters for tracking are created, configured, or removed via control directives received through user interface 208.

The presentation component 210 may be responsible for formatting information for display or communication. For instance, presentation component 210 may convert data stored in graph database 108 into a human-readable format. In some embodiments, the human-readable formats may include one or more illustrations included in the Figures provided herein. In various embodiments the presentation component 210 may implement a graphical user interface (GUI). In various such embodiments, presentation component 210 may cause the GUI to be displayed on user interface device 112. In some embodiments, one or more I/O functions regarding querying graph database 108 or controlling operational aspects of event correlation application 102 may be received through a GUI implemented by the presentation component 210.

FIG. 3 illustrates an embodiment of a snapshot of a cluster in a graph database 108. The graph database 108 may serve as a repository of nodes or vertices and associations or edges there between for representing the states of and relationships in the time-varying configuration of a cluster of objects, such as cluster 104. In some embodiments, snapshots, configuration graphs, and/or hierarchical time trees (HTTs) may implement the nodes and associations to improve the efficiency and flexibility of system 100. For instance, the graph database 108 may include one or more hierarchical time trees (HTTs) and each HTT may include a set of one or more associated nodes. In various such embodiments, each HTT may also be associated with one or more nodes in other HTTs. The nodes and associations between nodes in graph database 108 may enable relationships between various configurations of a cluster of objects to be identified and traced over time. In some embodiments relationships may be represented in graph database 108 with relationship vertices. Embodiments are not limited in this context.

As shown in FIG. 3, graph database 108 may include timestamp nodes 302, object nodes 304, and associations 306. In graph database 108 time-varying configurations of a cluster (e.g., cluster 104) or snapshot is represented with a set of nodes 302, 304 and associations 306. In some embodiments, the set of nodes 302, 304 and associations 306 may create a graph of interconnected objects. In various embodiments, time-varying configurations of a cluster may be tracked with associations and/or nodes within or between a plurality of sets of nodes and associations. In various such embodiments, the plurality of sets of nodes and associations may comprise one or more graphs of interconnected objects. In some embodiments, object nodes 304 may represent objects in a cluster or relationships between objects. In various embodiments, object and/or timestamp nodes 304, 302 may include properties. The set of nodes, associations, and properties for each snapshot, also referred to as the configuration node set, may include at least one timestamp node 302, at least one object node 304, and an association 306 or edge connecting at least two of the nodes 302, 304. In various embodiments, the configuration node set may include a set of stateful nodes and stateful relationships between the nodes.

In some embodiments, the timestamp nodes 302 represent a time or portion of the time associated with a configuration notification or snapshot. In some embodiments, the object nodes 302 represent objects and/or relationships present in the cluster at the time indicated in a configuration notification. Each object node may share a common set of properties (e.g., identifier, name, serial number, domain, etc.). In various embodiments object nodes 302 may be further classified into groups to represent object types. In various such embodiments, object node groups may include specific sets of properties (e.g., port). Object nodes 302 may also include stubs to get other data for the object (e.g., key to get counter data for a node). These stubs may enable access to predecessor and successor and latest and first snapshots of a cluster. For example, NEXT, LAST and FIRST edges/assocations may be used. In some embodiments, an index of commonly queried properties (e.g., identifier, name, type, etc.) may be maintained by event correlation application 102.

In various embodiments each node 302, 304 in a configuration node set may be referenced by one or more other configuration node sets. For example, when an original object node is created to represent an object added to cluster 104, each subsequent configuration notification that includes the object may result in the subsequent configuration node set including a reference to the original object node. In another example, snapshots of the cluster may be dependent on data utilized for one or more other or additional snapshots. In another example, timestamp nodes 302 that do or do not change between configuration notifications (e.g. minute, hour, day, month, year) may result in configuration node sets including references to one or more previous timestamp nodes. This may also result in promotion or demotion of a common timestamp node for a new node. These exemplary functionalities may improve utilization of storage space in graph database 108 and/or simplify identification of configuration changes between states of cluster 104.

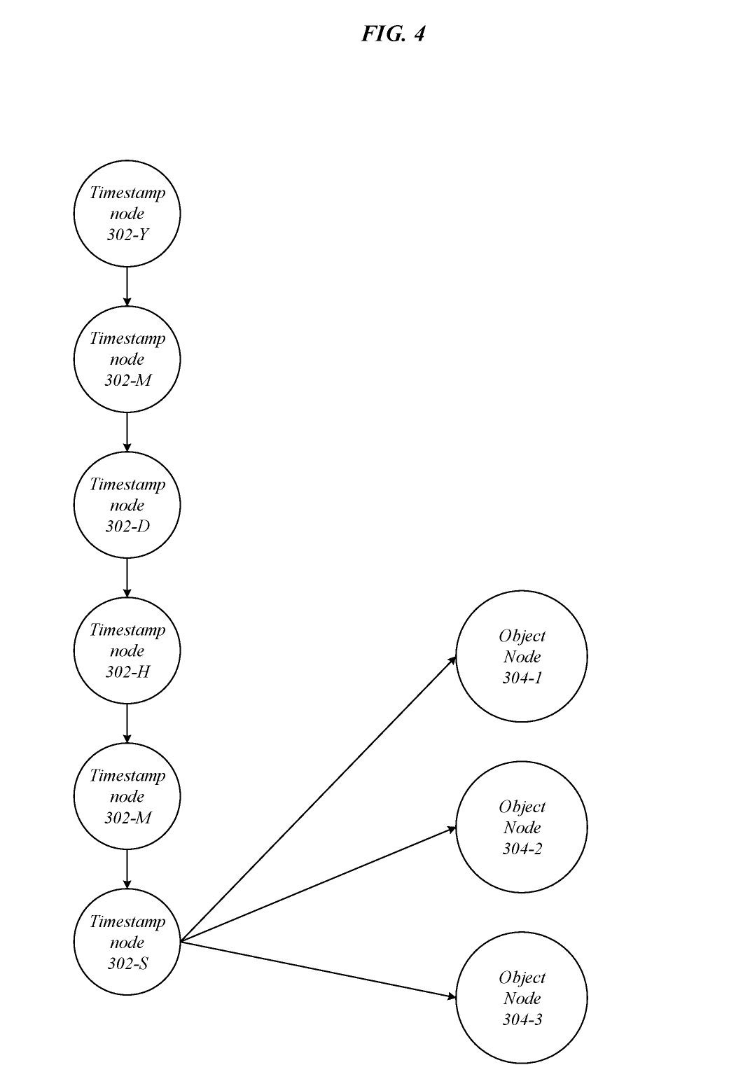

FIG. 4 illustrates one embodiment of a cluster configuration in graph database 108 or configuration node set is shown. The configuration node set includes timestamp nodes 302-Y, 302-Mo, 302-D, 302-H, 302-Mi, 302-S, object nodes 304-1, 304-2, 304-3, and the associations in between (i.e. connections or edges between nodes). Connections between various nodes 302, 304 represent associations or edges between the nodes. In various embodiments, the associations may be traced in either direction. In some embodiments, associations between nodes 302, 304 may not have properties. In various embodiments, nodes 302, 304 may be referred to as vertices while connections are referred to as edges. In the illustrated embodiment, properties of objects may be retained as properties of vertices. Embodiments are not limited in this context.

The configuration node set shown in FIG. 4 may be generated in response to receiving a configuration notification. For instance, the configuration notification may include a timestamp and three objects with properties associated with the cluster at the time indicated by the timestamp. The timestamp may include a year, month, day, hour, minute, and second. In response a set of timestamp nodes 302 may be generated, with each timestamp node in the set corresponding to a different unit of time included in the timestamp. In the illustrated embodiment timestamp node 302-Y corresponds to the year, timestamp node 302-Mo correspond to the month, timestamp node 302-D corresponds to the day, timestamp node 302-H corresponds to the hour, timestamp node 302-Mi corresponds to the minute, and timestamp node 302-S corresponds to the second of the timestamp included in the configuration notification. In some embodiments the timestamp nodes may hierarchically organized, with the largest of time (e.g. 302-Y) at the top and the smallest time (e.g. 302-S) at the bottom.

A common timestamp node (e.g. 302-S) in the set may be associated with each object node 304-1, 304-2, 304-3 in the cluster. Accordingly the configuration of the cluster associated with the timestamp may be determined by tracing the associations between the common timestamp node and object nodes. In the illustrated embodiments timestamp node 302-S is the common timestamp node and by tracing the associations between timestamp node 302-S, the configuration of the cluster at the time indicated by the timestamp can be shown to include object node 304-1, 304-2, 304-3. However, in other embodiments any timestamp node may serve as the common timestamp node and/or objects in a snapshot may be associated with common timestamp nodes at different time granularities. Further, selection of an appropriate timestamp node to serve as the common timestamp node may enable improved performance in some embodiments.

In some embodiments, each configuration node set may include or reference a root node. A root node may be associated which each cluster that the event correlation application 102 tracks. In various embodiments a query regarding a cluster may start at the root node with each configuration being traceable from the root node. In some embodiments the root node is associated with a run node. The run node may enable differentiation between timestamped and non-timestamped notification received by the event correlation application.

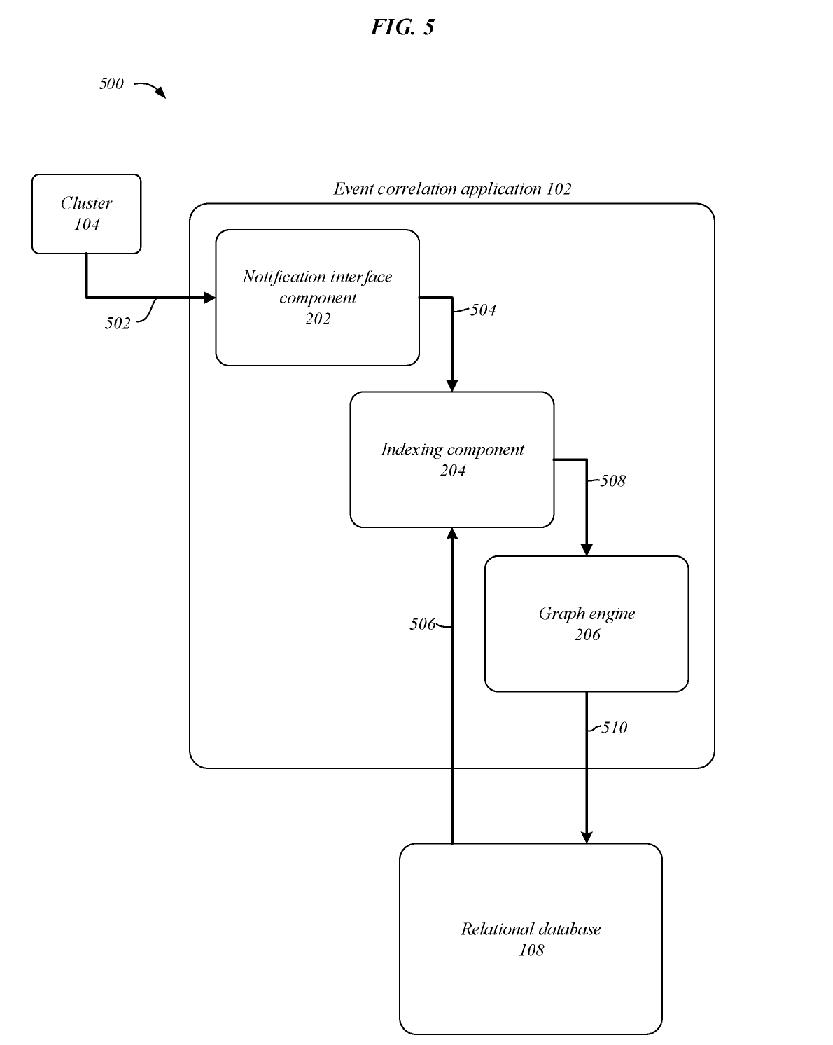

FIG. 5 illustrates an example process flow for maintaining a graph database of nodes and associations with event correlation application 102. In the exemplary process flow, the notification interface component 202, indexing component 204, and graph engine 206 are utilized by the event correlation application 102. Cluster 104 may provide data regarding the state or configuration of one or more object in the cluster. The event correlation application 102 may receive the state data and create one or more nodes and/or associations between nodes in the graph database 108 to represent the configuration of the cluster. Embodiments are not limited in this context.

At 502, the event correlation application 102 may receive a notification regarding the configuration of cluster 104 via the notification interface component 202. Data regarding the configuration may then be extracted by notification interface component 202 and provided to indexing component 204 as current configuration information at 504. In some embodiments, the notification interface component 202 may extract time information and configuration information from the received notification.

At 506, the indexing component 204 may retrieve a previous configuration of cluster 104 from graph database 108. The previous configuration information may indicate the state of the configuration at a prior moment in time, such as with a snapshot, for instance. In some embodiments the previous configuration information may represent the state of cluster 104 at the closest previous time indicated by a previously received notification. In various embodiments, the notification may be received out of temporal order. In various such embodiments, indexing component 204 may additionally retrieve future configuration information of cluster 104. The indexing component may compare the current configuration information to the previous configuration information to identify a configuration node set for the current configuration of the cluster 104. In some embodiments, indexing component 204 may utilize metadata based conditional rules to perform the comparison. In embodiments allowing out of order receipt of notifications, previous and future configuration information may be compared to the current configuration information to identify a configuration node set for the current configuration.

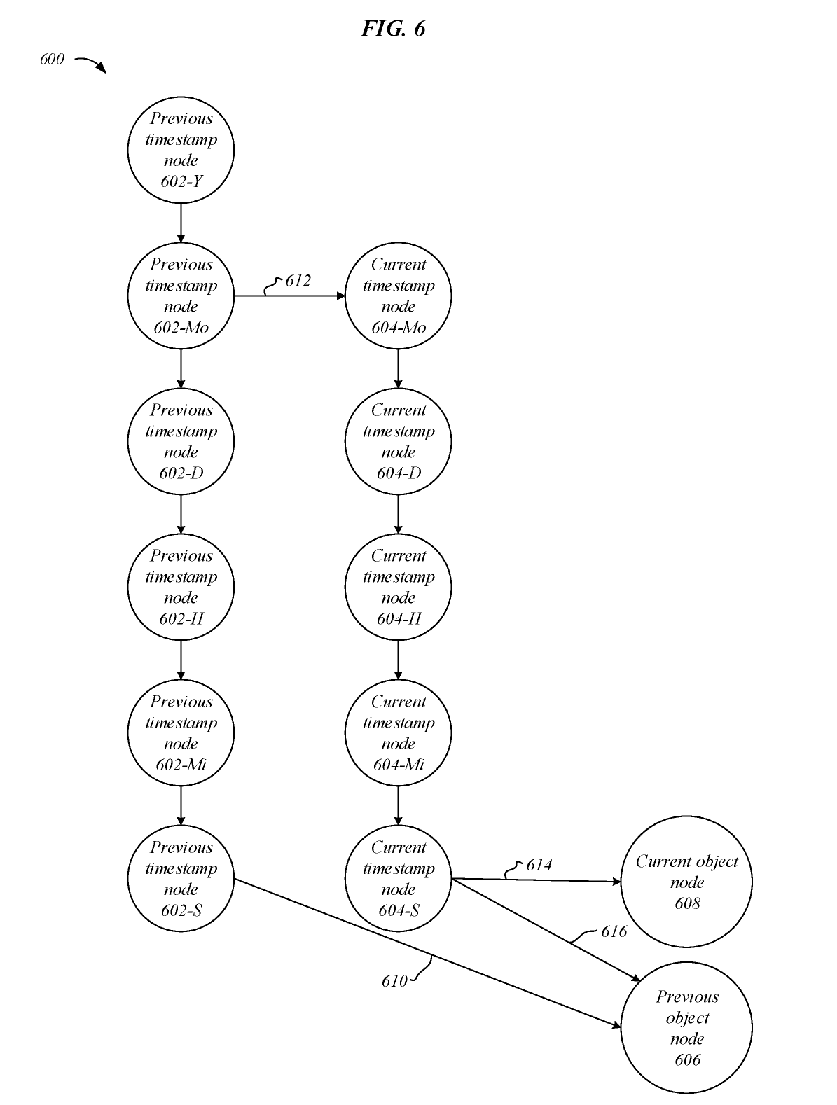

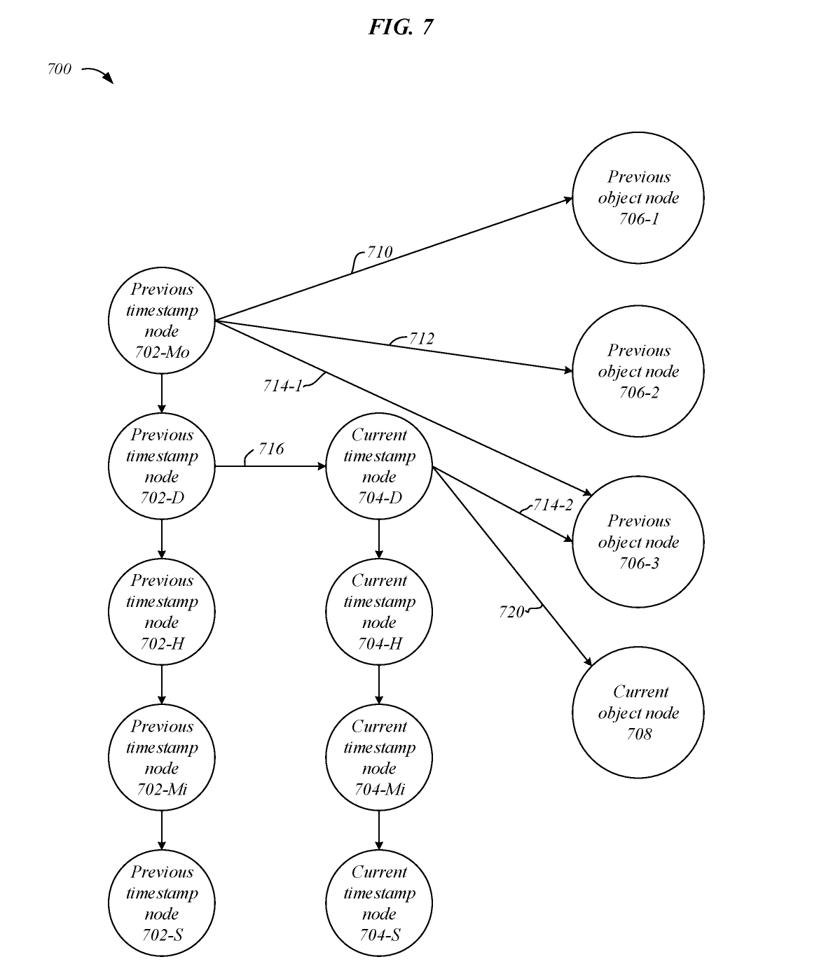

At 508, based on the configuration node set for the current configuration, indexing component 204 may direct graph engine 206 to create an object node to represent a new object added to cluster 104 as determined from the received notification. Indexing component 204 may also direct graph engine 206 to create a set of one or more timestamp nodes to represent a time associated with the current configuration of cluster 104. Node engine 206 may insert the created object and timestamp nodes into graph database 108 at 510. In some embodiment, the created object and timestamp nodes may be inserted as a HTT in graph database 108. Node engine 206 may also create associations between nodes in the graph database 108 to represent the current configuration of cluster 104. In some embodiments the associations between nodes are pointers or data references. Associations created by graph engine 206 may also enable the current configuration of cluster 104 to be related to previous and/or future configurations of cluster 104. Creating and associating nodes in graph database 108 will be described in greater detail with respect to FIG. 6 and FIG. 7.

FIG. 6 illustrates an embodiment of a first process flow for storing a cluster configuration in graph database 108. In some embodiments, this process flow may be used to efficiently represent dynamically changing data in graph database 108. A set of previous timestamp nodes 602-Y, 602-Mo, 602-D, 602-H, 602-Mi, 602-S and previous object node 606 comprise a previous configuration node set. A set of current timestamp nodes 604-Mo, 604-D, 604-H, 604-Mi, 604-S, current object node 608, and associations with previous timestamp node 602-Mo and previous object node 606 comprise a current configuration node set. For example, the previous configuration node set may indicate that in 2015 on March 3 at 6:10:20, the configuration of cluster 104 included previous object node 606 (see 610). A current notification regarding the state of cluster 104 may indicate that in 2015 on April 5 at 5:30:10 the configuration of cluster 104 included previous object node 606 and current object node 608 (see 614, 616). Embodiments are not limited in this context.

At 612, based on a comparison performed by the event correlation application 102, it can be determined that the previous and current configurations of cluster 104 occurred in the same year (e.g. 2015). Creating a new current timestamp node to represent the year (e.g. 2015) would result in redundant data in graph database 108, thus the event correlation application 102 may skip creating the new current timestamp node and instead use a reference to previous timestamp node 602-Mo. This arrangement may allow the current configuration of cluster 104 to be traced from previous timestamp node 602-Y or previous timestamp node 602-Mo. For example, if all configurations of cluster 104 during 2015 are desired, then previous timestamp node 602-Y can serve as a root from which all 2015 configurations can be traced and identified.

At 614, based on a comparison performed by the event correlation application 102, it can be determined that the previous configuration of cluster 104 did not include the object represented by current object node 608. In response event correlation application 102 may create current object node 608 and associate it with timestamp node 604-S. At 616, based on a comparison performed by the event correlation application 102, it can be determined that the previous and current configurations of cluster 104 included the object represented by previous object node 606. Creating a new current object node to represent previous object node 606 would result in redundant data in graph database 108, thus the event correlation application 102 may skip creating the new current object node and instead use an association (616) to previous object node 606. This arrangement may allow ready identification of each cluster configuration the previous object node 606 is associated with. In the illustrated embodiment, the lowest timestamp node (e.g., timestamp node 604-S) may serve as the common timestamp node for the current configuration node set.

In various embodiments, creating and associating nodes in graph database 108 may proceed according to a stitching algorithm. The following example explains how a different notification received by the event correlation application 102 may be stitched together and inserted into a graph database to provide a complete view of a cluster at any instance in time according to some embodiments. Graph Sink is a morphline command which may be invoked after event sink and counter sink is complete. Graph sink may build all the data to be ingested into the graph and calls gremlin scripts to push the data into the graph database. Embodiments are not limited in this context.

The different inputs utilized by the exemplary stitching algorithm may include defined file formats generated by a translation layer, such as Apache Avro file formats developed within Apache's Hadoop project, for example. In some embodiments there is one Avro file per object type. In various embodiments, Avro schema files may be generated by a metastore. In one embodiment, for example, an Extensible Markup Language (XML)-based file format for graphs (e.g., GraphML) from the data model describes different types of objects and the relationships among them. In some embodiments, GraphML may be accessed via common/metastore application program interface (API) calls. Stitching instructions may be provided by a data model. For example, the metastore API may read a JavaScript Object Notation (JSON) file and return all properties of a field.

The different stitching instructions defined in the data model may include compare, ignore, update, append, and/or abort. Stitching instruction is “compare” for a field where any change in the value field may result in two objects being not equal. Usually all configuration table fields may have stitching instruction as “compare.” When the stitching instruction is “ignore,” these fields may not be considered for comparison of two objects. All configuration table helper and header fields may have the instruction as “ignore.” If the stitching instruction is “update” for a field, the fields may not be considered for comparison and an old value of the field may be updated with a new value if the vertex is being reused. If the stitching instruction is “append,” then the value of the field in the new instance of the object may be appended to the field in the old instance if node is being reused or vice versa if it is being created. If the stitching instruction is “abort” then a client exception may be thrown and the ingestion may be exited. In some embodiments the “abort” instruction means some field which is not supposed to be ingested into the graph database is being ingested. For example, complex multiplication (CM) fields may have the instruction as “abort.”

The following operations illustrate an exemplary embodiment of a stitching algorithm with an example.

First, Avro files may be read to determine a list of object instances (e.g., nodes or vertices) to be inserted into the graph database. In some embodiments the Avro files are received as a configuration notification or an ASUP. In this example the list (ASUP2) may have the following instances: (cluster1, Node1, vs1*, Aggr1, Aggr3). Vs1 has some change in its state (indicated by *).

Second the last snapshot (i.e. configuration) of the cluster is retrieved, such as from the graph database, a cache, or in-memory. In this example (cluster 1, Node1, vs1, vs2, Aggr1, Aggr2) may be the last snapshot (ASUP1).

Third, for each instance in the list of object to be inserted, check if instance (node) exists in the last snapshot. If it exists in last snapshot, check if there is any change in the state (e.g., in one or more properties which maintain some state info for that object). If there is no change in the state reuse the object instance (e.g., node or vertex), if there is a change in the state create a new object instance in the graph database. Thus, object instances (cluster 1, Node1, Aggr1) may be reused; object instances (vs1*) may be created, as there was a change in the state; and object instances (Aggr3) may be created as it is a new node.

Fourth, once all the object instances are created or reused, the pending object instances (e.g., nodes or vertices in the last snapshot that were not present in the current snapshot) may be retrieved. In this example, the pending object instances may be (vs3, Aggr2).

Fifth, iterate through the pending object instances and case 1: move them to a new HTT or case 2: ignore them based on source node details. Case 1: ASUP2 may be from same node as ASUP1 (delete scenario). In this step, pending object instances may have (vs2, Aggr2). Since the ASUPs are from the same node, but ASUP2 did not include information of vs2 and Aggr2, it means a node which was seeing vs2 and aggr2 at a time instance (when ASUP1 was sent) is not seeing them anymore when ASUP2 was sent. Hence these may not be moved to a new HTT. Case 2: ASUP2 is from a different node (move scenario). In this step, pending object instances may have (vs2, Aggr2). As the ASUPs are from different nodes, these two pending object instances may be moved to a new HTT.

Sixth, establish the relationships between the vertices created/reused/moved in steps 3-5. Again, if a relationship existed in the last snapshot it may be reused. In this example, since (Cluster1, Node1) vertices are reused, there may already be a relationship in the last snapshot, which can be reused. Also, (vs1*) was recreated, thus the relationship between (Cluster1, vs1*) may be created.

FIG. 7 illustrates an embodiment of a second process flow for storing a cluster configuration in graph database 108. In some embodiments, this process flow may be used to efficiently represent dynamically changing data in graph database 108. A set of previous timestamp nodes 702-Mo, 702-D, 702-H, 702-Mi, 702-S, previous object nodes 706-1, 706-2, 706-3, and associations 710, 712, 714-1 represent a previous snapshot. A set of current timestamp nodes 704-D, 704-H, 704-Mi, 704-S, current object node 708, previous timestamp node 702-Mo, previous object node 706-3, previous object node 706-2, and associations 712, 714-2, 716, 720 represent a current snapshot. For example, the previous snapshot may indicate that on March 3 at 6:10:20, the configuration of cluster 104 included previous object nodes 706-1, 706-2, 706-3 (see 710, 712, 714-1). A current notification regarding the state of cluster 104 may indicate that on March 4 at 5:30:10 the configuration of cluster 104 included previous object nodes 706-2, 706-3 (see 712, 714-2), however a property change occurred with previous object node 706-3, and current object node 708 (see 720). In some embodiments, data may be moved up or down a timestamp tree/hierarchy based on how frequently the data changes (e.g. promotion/demotion described herein). Embodiments are not limited in this context.

At 716, based on a comparison performed by the event correlation application 102, it can be determined that the previous and current configurations of cluster 104 occurred in the same month (e.g. March). Creating a new current timestamp node to represent the month (e.g. March) would result in redundant data in graph database 108, thus the event correlation application 102 may skip creating the new current timestamp node and instead use a reference to previous timestamp node 702-D. This arrangement may allow the current configuration of cluster 104 to be traced from previous timestamp node 702-Mo or previous timestamp node 702-D. For example, if all configurations of cluster 104 during March are desired, then previous timestamp node 702-Mo can serve as a root from which all March configurations can be traced and identified. In some embodiments, predecessor, successor, last, and/or first snapshots may be accessed via associations and/or nodes created to track relationships between snapshots.

At 720, based on a comparison performed by the event correlation application 102, it can be determined that the previous configuration of cluster 104 did not include the object represented by current object node 708. In response event correlation application 102 may create current object node 708 and associate it with timestamp node 704-D. At 722 and 724, based on a comparison performed by the event correlation application 102, it can be determined that the previous and current configurations of cluster 104 included previous object node 706-2, 706-3, but not previous object node 706-1. The comparison may also determine that a property of previous object node 706-3 changed. In some embodiments, the time interval of property change may result in previous object node 706-3 being demoted from month to day time granularity, as shown by association 714-2. Creating a new current object node to represent previous object nodes 706-2, 706-3 would result in redundant data in graph database 108, thus the event correlation application 102 may skip creating new current object nodes and instead use references 722, 724 to previous object nodes 706-2, 706-3. This arrangement may allow ready identification of each cluster configuration the previous object nodes 706-2, 706-3 are associated with. For instance, because previous objet node 706-1 is not associated with the current snapshot, the current snapshot does not include associations 710.

In the illustrated embodiment, the highest timestamp node (e.g., timestamp node 704-D) newly created to represent the configuration of the cluster 104 may serve as the common timestamp node for the configuration node set. This technique may remove the need to trace to the lowest timestamp in the set to identify the configuration of the cluster 104. The benefits of this technique may be especially useful for tracking slow-changing data. For example, if the configuration of a cluster experiences changes in the order of days, then the event correlation application 102 can identify by tracing to the timestamp node associated with the day of the configuration, not the second.

In various embodiments, creating and associating nodes in graph database 108 may proceed according to the stitching algorithm described above with some modification. The modifications may deal with caching data, adding nodes, adding edges, implementing relationship vertices, and querying. Embodiments are not limited in this context.

Regarding caching data, data indicating the level of each object may be cached. Regarding adding nodes, three modification may be needed. First, need to invalidate previous configuration at higher level when object changes. In some embodiments this may be accomplished by adding a timestamp at which the previous configuration was last valid. Second, nodes may be demoted and added at a finer granular level (e.g. smaller units of time). For instance, if the previous configuration data is linked at the day level and this change is at the hour level, then the new data may be demoted to a finer time granularity and added at the hour level. Third, when the grandparent of unchanged data changes, the data should be linked at a particular level and the objects should be promoted to a coarser time granularity. For example, if Node1 object is last change at hour level and now a new configuration notification has been received on a different day and Node1 has not change, the data should be promoted and associated at the day level in the graph database 108.

Regarding modification to adding edges, old edges need to be invalidated. In some embodiments old edges may be invalidated by adding a timestamp at which they were last valid. Regarding implementing relationship vertices, relationship vertices should be at the same level as the lowest level among the two end vertices. Regarding querying, two modifications may be needed. First to get all vertices, The HTT may be traversed to get data from each level. In various embodiments, edge comparison is also involved. In some embodiments the data should be deduplicated. This modification may result in more vertices being touched (e.g. traced, analyzed, etc.) as data from each level in the HTT may be checked if they are valid at a particular timestamp. Second, relationships of a particular instance should be deduplicated at different levels and the edge vertex linked at a particular level must be retrieved.

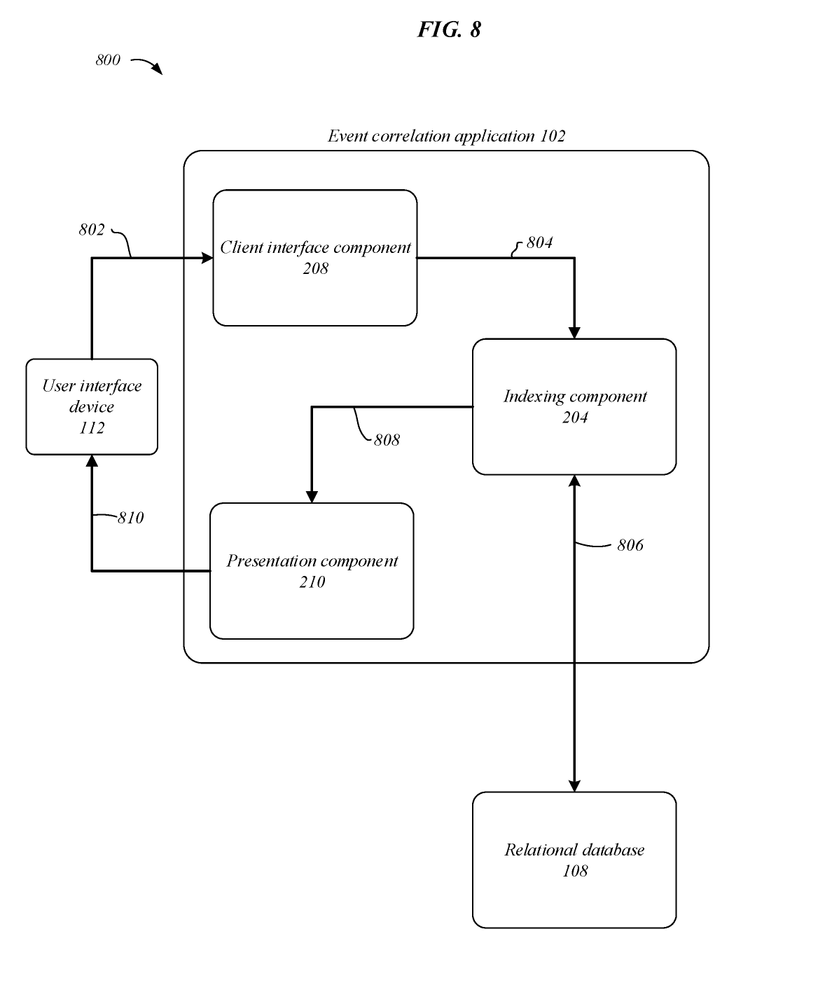

FIG. 8 illustrates an example process flow for querying a graph database of nodes and associations with event correlation application 102. In the exemplary process flow, the client interface component 208, indexing component 204, and presentation component 210 are utilized by the event correlation application 102. User interface device 112 may submit requests to the event correlation application 102, such as to query graph database 108, for example. These queries may identify one or more time points, time periods, clusters, objects, and/or associations related to the desired information for the event correlation application 102 to utilize. Event correlation application 102 may respond to the requests by sending information for display by the user interface device 112. In some embodiments, a GUI may be displayed on the user interface device 112 to facilitate requests submissions and responses. Embodiments are not limited in this context.

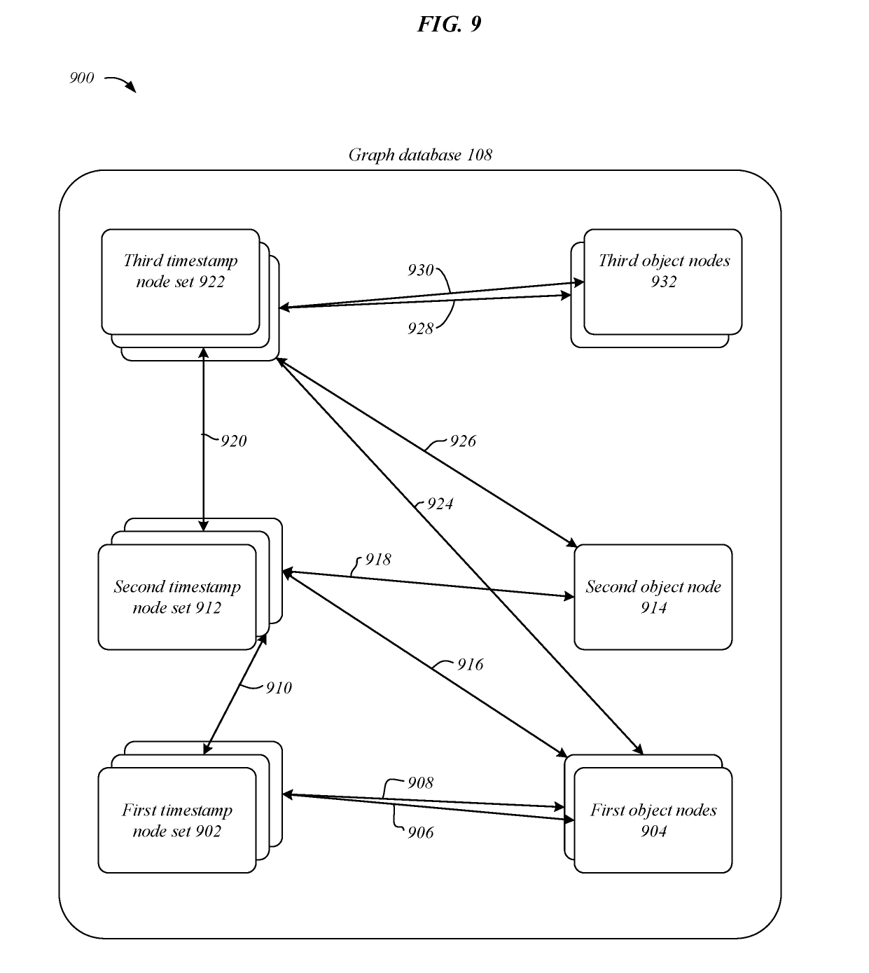

At 802, the event correlation application 102 may receive a request for data regarding the configuration of a cluster, such as cluster 104, via client interface component 208. For instance, the request may identify a time period that the configuration of cluster 104 is desired. Data regarding the configuration may then be extracted by client interface component 208 and provided to indexing component 204 as query information at 804. In some embodiments, the client interface component 208 may extract the time period identified in the request. At 806, the indexing component 204 may trace associations in the graph database 108 based on the query information to identify relevant query results. Tracing of associations in the graph database 108 will be described in more detail with respect to FIG. 9. The indexing component 204 may then pass the relevant query results to presentation component 210 at 808. The presentation component 210 may format the relevant query results and cause them to be displayed on the user interface device 112 at 810.

As may be appreciated the steps described with respect to FIG. 8 may generally be repeated numerous times in response to other or additional requests received by the event correlation application 102. For example, a user may submit a request to adjust the period of time for which configuration data is displayed. In another example, a user may submit a request to identify the objects that changed during a period of time. In another example, a user may submit a request to identify the period of time that an object was included in a cluster. In another example, a user may submit a request for properties of an object. In another example, a user may submit a request to identify children of a node. Each of these example requests may be fulfilled, in any order, by event correlation application 102.

FIG. 9 illustrates an embodiment of a process flow for tracing associations in graph database 108. Associations may be traced, in either direction, by the event correlation application 102 to identify states or state changes regarding one or more object in a cluster. These associations may enable efficient retrieval of data relevant to the configuration of the cluster. Embodiments are not limited in this context.

In FIG. 9, first timestamp nodes set 902 and first object nodes 904 may represent the original configuration node set of the cluster. The first timestamp node set 902 may indicate the time that first object nodes 904 were created and added to graph database 108. Associations 906, 908 may indicate the configuration of the cluster originally included first object nodes 904.

Association 910 may be traced from the first timestamp node set 902 to the second timestamp node set 912 to identify a configuration of the cluster at a time associated with a first configuration change. At this time, second object node 914 may have been added to the cluster while one of the first object nodes 904 was removed. This is illustrated with associations 916, 918 indicating the configuration of the cluster at the time represented by second timestamp node set 912.

Association 920 may be traced from the second timestamp node set 912 to the third timestamp node set 922 to identify a configuration of the cluster at a time associated with a second configuration change. At this time, third object nodes 932 may have been added to the cluster. This is illustrated with associations 924, 926, 928, 930 indicating the configuration of the cluster at the time represented by third timestamp node set 922.

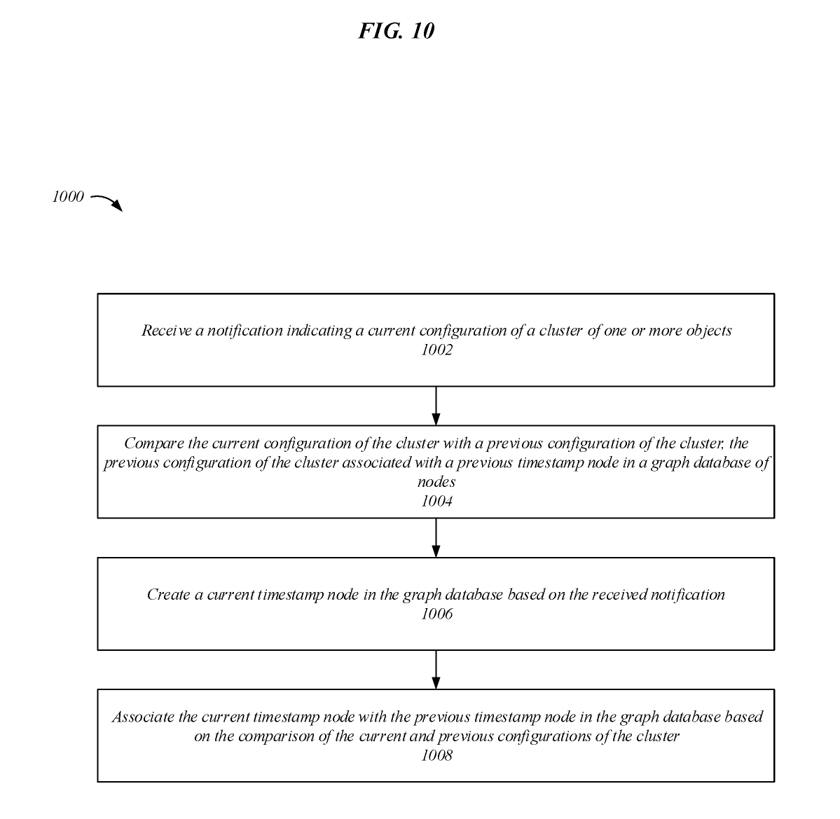

FIG. 10 illustrates one embodiment of a logic flow 1000. The logic flow 1000 may be representative of some or all of the operations executed by one or more embodiments described herein, such as the system 100 or the event correlation application 102. Embodiments are not limited in this context.

In the illustrated embodiment shown in FIG. 10, the logic flow 1000 may receive a notification indicating a current configuration of a cluster of one or more objects at 1002. At 1004 the current configuration of the cluster may be compared with a previous configuration of the cluster. In some embodiments, the previous configuration of the cluster may be associated with a previous timestamp node in a graph database of nodes and associations. At 1006, a current timestamp node may be created in the graph database based on the received notification. At 1008, the current timestamp node may be associated with the previous timestamp node in the graph database based on the comparison of the current and previous configurations of the cluster.

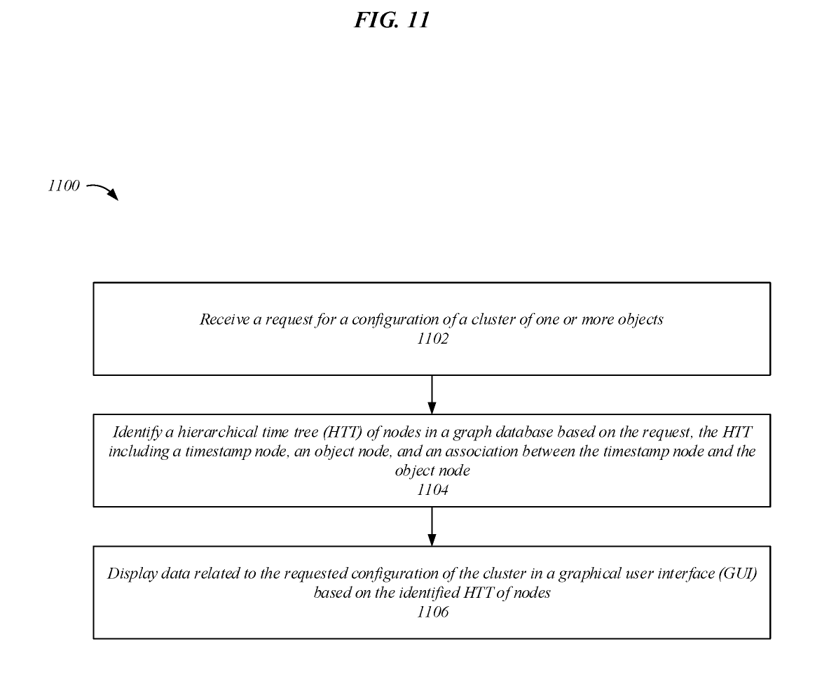

FIG. 11 illustrates one embodiment of a logic flow 1100. The logic flow 1100 may be representative of some or all of the operations executed by one or more embodiments described herein, such as the system 100 or the event correlation application 102. Embodiments are not limited in this context.

In the illustrated embodiment shown in FIG. 11, the logic flow 1100 may receive a request for a configuration of a cluster of one or more objects at 1102. At 1104, a hierarchical time tree (HTT) of nodes in a graph database may be identified based on the request. In some embodiments the HTT includes a timestamp node, an object node, and an association between the timestamp node and the object node. At 1106, data related to the requested configuration of the cluster may be displayed in a graphical user interface (GUI) based on the identified HTT of nodes.

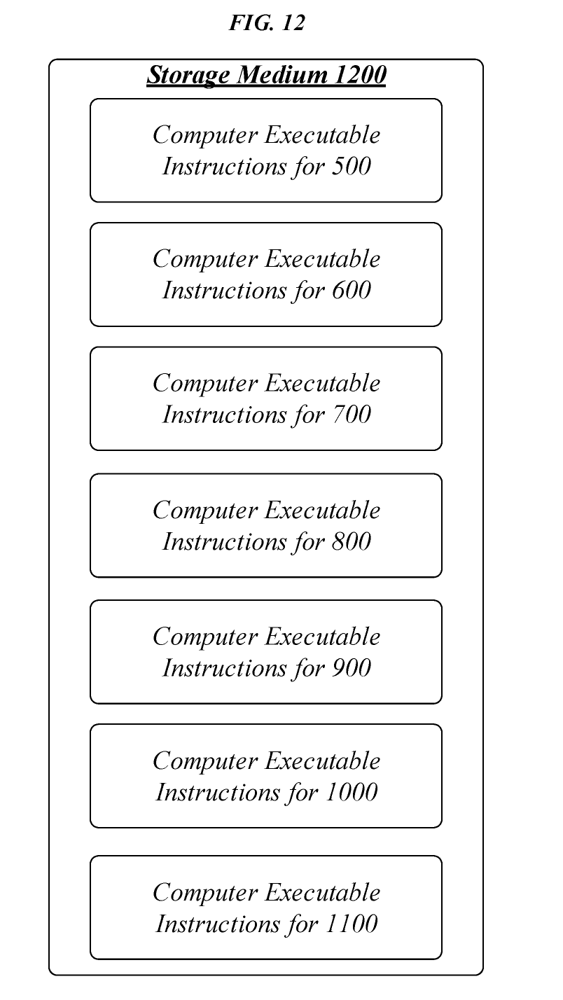

FIG. 12 illustrates an embodiment of a storage medium 1200. Storage medium 1200 may comprise any non-transitory computer-readable storage medium or machine-readable storage medium, such as an optical, magnetic or semiconductor storage medium. In various embodiments, storage medium 1200 may comprise an article of manufacture. In some embodiments, storage medium 1200 may store computer-executable instructions, such as computer-executable instructions to implement one or more of logic flows 500, 600, 700, 800, 900, 1000, 1100 of FIGS. 5-11. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

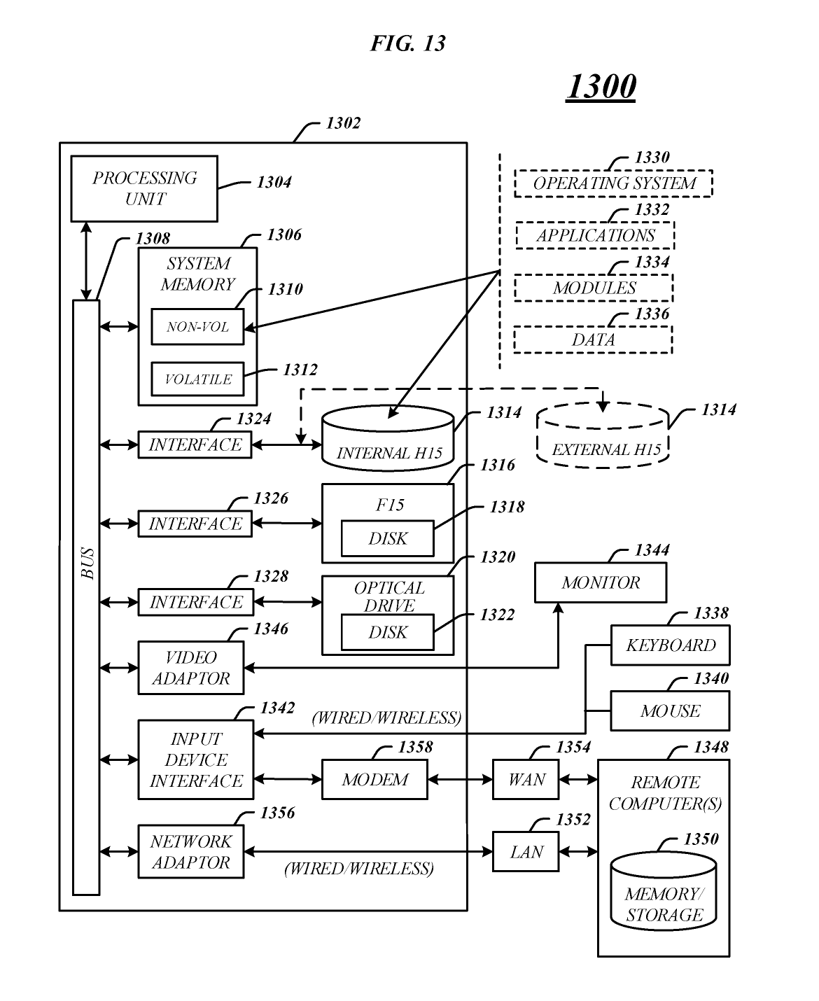

FIG. 13 illustrates an embodiment of an exemplary computing architecture 1300 that may be suitable for implementing various embodiments as previously described. In various embodiments, the computing architecture 1300 may comprise or be implemented as part of an electronic device. In some embodiments, the computing architecture 1300 may be representative, for example, of a processor server that implements one or more components of the storage management application 104. In some embodiments, computing architecture 1300 may be representative, for example, of a mobile device that implements one or more component of mobile storage application 110. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 1300. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1300 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1300.

As shown in FIG. 13, the computing architecture 1300 comprises a processing unit 1304, a system memory 1306 and a system bus 1308. The processing unit 1304 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1304.

The system bus 1308 provides an interface for system components including, but not limited to, the system memory 1306 to the processing unit 1304. The system bus 1308 can be any of several types of bus structure that may further interconnect to a memory bus (with or without a memory controller), a peripheral bus, and a local bus using any of a variety of commercially available bus architectures. Interface adapters may connect to the system bus 1308 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1306 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 13, the system memory 1306 can include non-volatile memory 1310 and/or volatile memory 1312. A basic input/output system (BIOS) can be stored in the non-volatile memory 1310.

The computer 1302 may include various types of computer-readable storage media in the form of one or more lower speed memory units, including an internal (or external) hard disk drive (HDD) 1314, a magnetic floppy disk drive (FDD) 1316 to read from or write to a removable magnetic disk 1318, and an optical disk drive 1320 to read from or write to a removable optical disk 1322 (e.g., a CD-ROM or DVD). The HDD 1314, FDD 1316 and optical disk drive 1320 can be connected to the system bus 1308 by a HDD interface 1324, an FDD interface 1326 and an optical drive interface 1328, respectively. The HDD interface 1324 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1310, 1312, including an operating system 1330, one or more application programs 1332, other program modules 1334, and program data 1336. In one embodiment, the one or more application programs 1332, other program modules 1334, and program data 1336 can include, for example, the various applications and/or components of the system 100.

A user can enter commands and information into the computer 1302 through one or more wire/wireless input devices, for example, a keyboard 1338 and a pointing device, such as a mouse 1340. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1304 through an input device interface 1342 that is coupled to the system bus 1308, but can be connected by other interfaces such as a parallel port, IEEE 1394 serial port, a game port, a USB port, an IR interface, and so forth.

A monitor 1344 or other type of display device is also connected to the system bus 1308 via an interface, such as a video adaptor 1346. The monitor 1344 may be internal or external to the computer 1302. In addition to the monitor 1344, a computer typically includes other peripheral output devices, such as speakers, printers, and so forth.

The computer 1302 may operate in a networked environment using logical connections via wire and/or wireless communications to one or more remote computers, such as a remote computer 1348. The remote computer 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wire/wireless connectivity to a local area network (LAN) 1352 and/or larger networks, for example, a wide area network (WAN) 1354. Such LAN and WAN networking environments are commonplace in offices and companies, and facilitate enterprise-wide computer networks, such as intranets, all of which may connect to a global communications network, for example, the Internet.

When used in a LAN networking environment, the computer 1302 is connected to the LAN 1352 through a wire and/or wireless communication network interface or adaptor 1356. The adaptor 1356 can facilitate wire and/or wireless communications to the LAN 1352, which may also include a wireless access point disposed thereon for communicating with the wireless functionality of the adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wire and/or wireless device, connects to the system bus 1308 via the input device interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

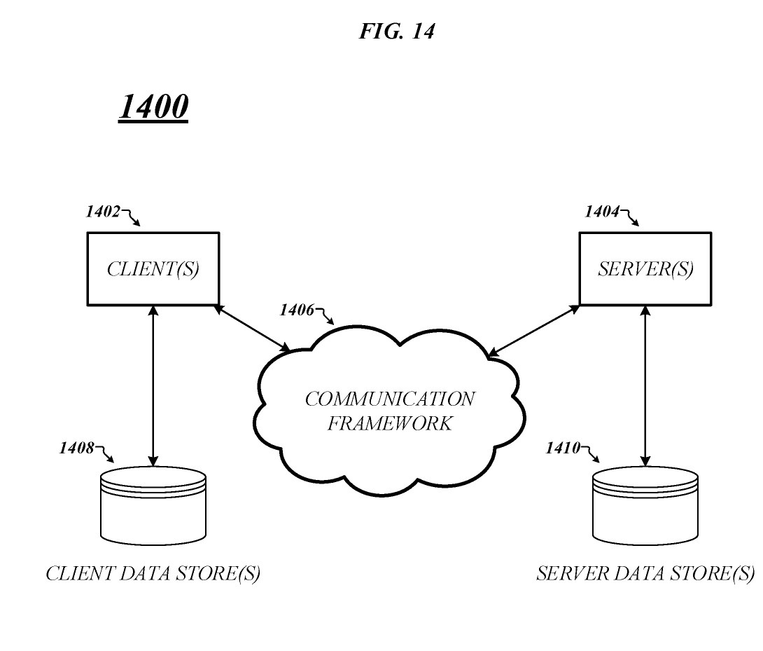

FIG. 14 illustrates a block diagram of an exemplary communications architecture 1400 suitable for implementing various embodiments as previously described. The communications architecture 1400 includes various common communications elements, such as a transmitter, receiver, transceiver, radio, network interface, baseband processor, antenna, amplifiers, filters, power supplies, and so forth. The embodiments, however, are not limited to implementation by the communications architecture 1400.

As shown in FIG. 12, the communications architecture 1400 comprises includes one or more clients 1402 and servers 1404. The clients 1402 and the servers 1404 are operatively connected to one or more respective client data stores 1408 and server data stores 1410 that can be employed to store information local to the respective clients 1402 and servers 1404, such as cookies and/or associated contextual information. In various embodiments, any one of servers 1404 may implement one or more of logic flows 500-1100 of FIGS. 5-11, and storage medium 1200 of FIG. 12 in conjunction with storage of data received from any one of clients 1402 on any of server data stores 1410.

The clients 1402 and the servers 1404 may communicate information between each other using a communication framework 1406. The communications framework 1406 may implement any well-known communications techniques and protocols. The communications framework 1406 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1406 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1402 and the servers 1404. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is an apparatus, comprising logic, at least a portion of which is implemented in hardware, the logic comprising an event correlation application to manage a graph database of nodes and associations and associations regarding configurations of a cluster of one or more objects, the event correlation application comprising: a notification interface component to receive a notification, the notification to indicate a current configuration of the cluster; an indexing component to compare the current configuration of the cluster with a previous configuration of the cluster, wherein the previous configuration of the cluster is associated with a previous timestamp node in the graph database; and a graph engine to create a current timestamp node based on the received notification and associate the current timestamp node with the previous timestamp node in the graph database based on the comparison of the current and previous configurations of the cluster.

Example 2 includes the subject matter of Example 1, the indexing component to identify a configuration change between the previous configuration and the current configuration of the cluster based on the comparison of the current configuration to the previous configuration of the cluster.

Example 3 includes the subject matter of Example 2, the configuration change comprising an object present in the previous configuration of the cluster and absent from the current configuration of the cluster.

Example 4 includes the subject matter of Example 2, the configuration change comprising an object present in the current configuration of the cluster and absent from the previous configuration of the cluster.

Example 5 includes the subject matter of Example 4, the graph engine to create a current object node to represent the configuration change in the representational database and associate the current object node with the current timestamp node in the representational database.

Example 6 includes the subject matter of Example 5, the current object node comprising one or more properties of the object present in the current configuration of the cluster and absent from the previous configuration of the cluster.

Example 7 includes the subject matter of Example 1, wherein the previous configuration of the cluster is associated with a previous object node in the graph database, the previous object node to represent a configuration of an object in the cluster at a previous moment in time.

Example 8 includes the subject matter of Example 7, the graph engine to associate the current timestamp node with the previous object node in the graph database.

Example 9 includes the subject matter of Example 8, wherein the configuration of the object represented by the previous object node remains unchanged between the previous configuration of the cluster and the current configuration of the cluster.

Example 10 includes the subject matter of Example 1, the graph database comprising one or more hierarchical time trees (HTTs).

Example 11 includes the subject matter of Example 1, the previous configuration of the cluster associated with a previous set of timestamp nodes including the previous timestamp node, each timestamp node of the previous set to correspond to a different unit of time associated with the previous configuration of the cluster.

Example 12 includes the subject matter of Example 11, the different units of time comprising one or more of seconds, minutes, hours, days, months, and years.

Example 13 includes the subject matter of Example 11, the previous timestamp node and the current timestamp node to correspond to an equivalent unit of time.

Example 14 includes the subject matter of Example 11, wherein each timestamp node in the previous set of timestamp nodes is hierarchically organized in the graph database according the unit of time corresponding to each timestamp node, with the largest unit of time at the top of the hierarchy.

Example 15 includes the subject matter of Example 14, the previous timestamp node comprising the lowest timestamp node in the previous set of timestamp nodes.

Example 16 includes the subject matter of Example 14, the previous timestamp node comprising the highest timestamp node in the previous set of timestamp nodes.

Example 17 includes the subject matter of Example 1, the notification comprising a current timestamp including a plurality of units of time to indicate a time associated with the current configuration of the cluster, the graph engine to generate a current set of timestamp nodes including the current timestamp node based on the current timestamp, with each timestamp node to correspond to a different unit of time.

Example 18 includes the subject matter of Example 17, the plurality of units of time comprising two or more of seconds, minutes, hours, days, months, and years.

Example 19 includes the subject matter of Example 17, the current timestamp node and the previous timestamp node to correspond to an equivalent unit of time.

Example 20 includes the subject matter of Example 17, wherein each timestamp node in the current set is hierarchically organized in the graph database according to the unit of time corresponding to each timestamp node, with the largest unit of time at the top of the hierarchy.

Example 21 includes the subject matter of Example 20, the current timestamp node comprising the lowest timestamp node in the current set of timestamp nodes.

Example 22 includes the subject matter of Example 20, the current timestamp node comprising the highest timestamp node in the current set of timestamp nodes.

Example 23 includes the subject matter of Example 1, the notification interface component to receive the notification from a remote data store via a computer network.

Example 24 includes the subject matter of Example 1, the notification interface component to receive the notification from a local data store.

Example 25 is a computer-implemented method, comprising: receiving a notification indicating a current configuration of a cluster of one or more objects; comparing the current configuration of the cluster with a previous configuration of the cluster, the previous configuration of the cluster associated with a previous timestamp node in a graph database of nodes and associations; creating a current timestamp node in the graph database based on the received notification; and associating the current timestamp node with the previous timestamp node in the graph database based on the comparison of the current and previous configurations of the cluster.

Example 26 includes the subject matter of Example 25, comprising identifying a configuration change between the previous configuration and the current configuration of the cluster based on the comparison of the current configuration to the previous configuration of the cluster.

Example 27 includes the subject matter of Example 26, the configuration change comprising an object present in the previous configuration of the cluster and absent from the current configuration of the cluster.

Example 28 includes the subject matter of Example 26, the configuration change comprising an object present in the current configuration of the cluster and absent from the previous configuration of the cluster.

Example 29 includes the subject matter of Example 28, comprising: creating a current object node to represent the configuration change in the representational database; and associating the current object node with the current timestamp node in the representational database.

Example 30 includes the subject matter of Example 29, the current object node comprising one or more properties of the object present in the current configuration of the cluster and absent from the previous configuration of the cluster.

Example 31 includes the subject matter of Example 25, the previous configuration of the cluster associated with a previous object node in the graph database, the previous object node representing a configuration of an object in the cluster at a previous moment in time.

Example 32 includes the subject matter of Example 31, comprising associating the current timestamp node with the previous object node in the graph database when the configuration of the object represented by the previous object node remains unchanged between the previous configuration of the cluster and the current configuration of the cluster.

Example 33 includes the subject matter of Example 25, the graph database comprising one or more hierarchical time trees (HTTs).

Example 34 includes the subject matter of Example 25, the previous configuration of the cluster associated with a previous set of timestamp nodes including the previous timestamp node, each timestamp node of the previous set corresponding to a different unit of time associated with the previous configuration of the cluster.

Example 35 includes the subject matter of Example 34, the different units of time comprising one or more of seconds, minutes, hours, days, months, and years.

Example 36 includes the subject matter of Example 34, the previous timestamp node and the current timestamp node corresponding to an equivalent unit of time.

Example 37 includes the subject matter of Example 34, each timestamp node in the previous set of timestamp nodes hierarchically organized in the graph database according the unit of time corresponding to each timestamp node, with the largest unit of time at the top of the hierarchy.

Example 38 includes the subject matter of Example 37, the previous timestamp node comprising the lowest timestamp node in the previous set of timestamp nodes.

Example 39 includes the subject matter of Example 37, the previous timestamp node comprising the highest timestamp node in the previous set of timestamp nodes.

Example 40 includes the subject matter of Example 25, comprising: receiving a current timestamp having a plurality of units of time indicating a time associated with the current configuration of the cluster; and generating a current set of timestamp nodes including the current timestamp node based on the current timestamp, with each timestamp node corresponding to a different unit of time.

Example 41 includes the subject matter of Example 40, the plurality of units of time comprising two or more of seconds, minutes, hours, days, months, and years.

Example 42 includes the subject matter of Example 40, the current timestamp node and the previous timestamp node corresponding to an equivalent unit of time.

Example 43 includes the subject matter of Example 40, each timestamp node in the current set hierarchically organized in the graph database according to the unit of time corresponding to each timestamp node, with the largest unit of time at the top of the hierarchy.

Example 44 includes the subject matter of Example 43, the current timestamp node comprising the lowest timestamp node in the current set of timestamp nodes.

Example 45 includes the subject matter of Example 43, the current timestamp node comprising the highest timestamp node in the current set of timestamp nodes.

Example 46 includes the subject matter of Example 25, comprising receiving the notification from a remote data store via a computer network.

Example 47 includes the subject matter of Example 25, comprising receiving the notification from a local data store.

Example 48 is one or more computer-readable media to store instructions that when executed by a processor circuit causes the processor circuit to: receive a notification indicating a current configuration of a cluster of one or more objects; compare the current configuration of the cluster with a previous configuration of the cluster, the previous configuration of the cluster associated with a previous timestamp node in a graph database of nodes and associations; create a current timestamp node in the graph database based on the received notification; and associate the current timestamp node with the previous timestamp node in the graph database based on the comparison of the current and previous configurations of the cluster

Example 49 includes the subject matter of Example 48, with instructions to identify a configuration change between the previous configuration and the current configuration of the cluster based on the comparison of the current configuration to the previous configuration of the cluster.

Example 50 includes the subject matter of Example 49, the configuration change comprising an object present in the previous configuration of the cluster and absent from the current configuration of the cluster.

Example 51 includes the subject matter of Example 49, the configuration change comprising an object present in the current configuration of the cluster and absent from the previous configuration of the cluster.

Example 52 includes the subject matter of Example 51, with instructions to: create a current object node to represent the configuration change in the representational database; and associate the current object node with the current timestamp node in the representational database.

Example 53 includes the subject matter of Example 52, the current object node comprising one or more properties of the object present in the current configuration of the cluster and absent from the previous configuration of the cluster.

Example 54 includes the subject matter of Example 48, the previous configuration of the cluster associated with a previous object node in the graph database, the previous object node to represent a configuration of an object in the cluster at a previous moment in time.

Example 55 includes the subject matter of Example 54, with instructions to associate the current timestamp node with the previous object node in the graph database when the configuration of the object represented by the previous object node remains unchanged between the previous configuration of the cluster and the current configuration of the cluster.

Example 56 includes the subject matter of Example 48, the graph database comprising one or more hierarchical time trees (HTTs).

Example 57 includes the subject matter of Example 48, the previous configuration of the cluster associated with a previous set of timestamp nodes including the previous timestamp node, each timestamp node of the previous set to correspond to a different unit of time associated with the previous configuration of the cluster.

Example 58 includes the subject matter of Example 57, the different units of time comprising one or more of seconds, minutes, hours, days, months, and years.

Example 59 includes the subject matter of Example 57, the previous timestamp node and the current timestamp node to correspond to an equivalent unit of time.

Example 60 includes the subject matter of Example 57, each timestamp node in the previous set of timestamp nodes hierarchically organized in the graph database according the unit of time corresponding to each timestamp node, with the largest unit of time at the top of the hierarchy.

Example 61 includes the subject matter of Example 60, the previous timestamp node comprising the lowest timestamp node in the previous set of timestamp nodes.

Example 62 includes the subject matter of Example 60, the previous timestamp node comprising the highest timestamp node in the previous set of timestamp nodes.

Example 63 includes the subject matter of Example 48, with instructions to: receive a current timestamp having a plurality of units of time indicating a time associated with the current configuration of the cluster; and generate a current set of timestamp nodes including the current timestamp node based on the current timestamp, with each timestamp node corresponding to a different unit of time.

Example 64 includes the subject matter of Example 63, the plurality of units of time comprising two or more of seconds, minutes, hours, days, months, and years.

Example 65 includes the subject matter of Example 63, the current timestamp node and the previous timestamp node to correspond to an equivalent unit of time.

Example 66 includes the subject matter of Example 63, each timestamp node in the current set hierarchically organized in the graph database according to the unit of time corresponding to each timestamp node, with the largest unit of time at the top of the hierarchy.

Example 67 includes the subject matter of Example 66, the current timestamp node comprising the lowest timestamp node in the current set of timestamp nodes.

Example 68 includes the subject matter of Example 66, the current timestamp node comprising the highest timestamp node in the current set of timestamp nodes.

Example 69 includes the subject matter of Example 48, with instructions to receive the notification from a remote data store via a computer network.

Example 70 includes the subject matter of Example 48, with instructions to receive the notification from a local data store.

Example 71 is an apparatus, comprising: logic, at least a portion of which is implemented in hardware, the logic comprising an event correlation application to query a graph database of nodes and associations regarding configurations of a cluster of one or more objects, the event correlation application comprising: a client interface component to receive a request for a configuration of the cluster; an indexing component to identify a hierarchical time tree (HTT) of nodes and associations in the graph database based on the request, the HTT to include a timestamp node, an object node, and an association between the timestamp node and the object node; and a presentation component to display data related to the requested configuration of the cluster in a graphical user interface (GUI) based on the identified HTT of nodes and associations.

Example 72 includes the subject matter of Example 71, the request for the configuration of the cluster comprising a moment in time.

Example 73 includes the subject matter of Example 72, the data displayed comprising a set of object nodes to represent the configuration of the cluster at the moment in time.

Example 74 includes the subject matter of Example 73, the presentation component to adjust the moment in time for which configuration data is displayed by the presentation component based on input received via the client interface component.

Example 75 includes the subject matter of Example 71, the request for the configuration of the cluster comprising a period of time.

Example 76 includes the subject matter of Example 75, the data displayed comprising a timeline for the configuration of the cluster over the period of time.

Example 77 includes the subject matter of Example 76, the presentation component to adjust the period of time displayed in the timeline based on input received via the client interface component.

Example 78 includes the subject matter of Example 76, the presentation component to adjust a unit of time displayed in the timeline based on input received via the client interface component.

Example 79 includes the subject matter of Example 71, the HTT comprising an object node for each of one or more objects in the requested cluster configuration.

Example 80 includes the subject matter of Example 79, wherein each object node includes a common set of properties.

Example 81 includes the subject matter of Example 71, the indexing component to identify the HTT in the graph database by tracing associations between nodes in the graph database.

Example 82 includes the subject matter of Example 71, the data displayed including a HTT.

Example 83 includes the subject matter of Example 71, the data displayed including a set of object nodes to represent the requested configuration of the cluster.

Example 84 includes the subject matter of Example 83, the client interface component to receive a selection of an object node in the displayed set of object nodes and, in response, the presentation component to display a set of properties of the selected object node in the GUI.

Example 85 is a computer-implemented method, comprising: receiving a request for a configuration of a cluster of one or more objects; identifying a hierarchical time tree (HTT) of nodes and associations in a graph database based on the request, the HTT including a timestamp node, an object node, and an association between the timestamp node and the object node; and displaying data related to the requested configuration of the cluster in a graphical user interface (GUI) based on the identified HTT of nodes and associations.

Example 86 includes the subject matter of Example 85, the request for the configuration of the cluster including a moment in time.

Example 87 includes the subject matter of Example 86, the data displayed including a set of object nodes representing the configuration of the cluster at the moment in time.

Example 88 includes the subject matter of Example 87, comprising adjusting the moment in time for which configuration data is displayed based on input received via the client interface component.

Example 89 includes the subject matter of Example 85, the request for the configuration of the cluster including a period of time.

Example 90 includes the subject matter of Example 89, the data displayed comprising a timeline for the configuration of the cluster over the period of time.

Example 91 includes the subject matter of Example 90, comprising adjusting the period of time displayed in the timeline based on input received via the client interface component.

Example 92 includes the subject matter of Example 90, comprising adjusting a unit of time displayed in the timeline based on input received via the client interface component.

Example 93 includes the subject matter of Example 85, the HTT including an object node for each of one or more objects in the requested cluster configuration.

Example 94 includes the subject matter of Example 93, each object node including a common set of properties.

Example 95 includes the subject matter of Example 85, comprising identifying the HTT in the graph database by tracing associations between nodes in the graph database.

Example 96 includes the subject matter of Example 85, the data displayed including a HTT.

Example 97 includes the subject matter of Example 85, the data displayed including a set of object nodes representing the requested configuration of the cluster.

Example 98 includes the subject matter of Example 97, comprising receiving a selection of an object node in the displayed set of object nodes and, in response, displaying a set of properties of the selected object node in the GUI.

Example 99 is one or more computer-readable media to store instructions that when executed by a processor circuit causes the processor circuit to: receive a request for a configuration of a cluster of one or more objects; identify a hierarchical time tree (HTT) of nodes and associations in a graph database based on the request, the HTT including a timestamp node, an object node, and an association between the timestamp node and the object node; and display data related to the requested configuration of the cluster in a graphical user interface (GUI) based on the identified HTT of nodes and associations.

Example 100 includes the subject matter of Example 99, the request for the configuration of the cluster comprising a moment in time.

Example 101 includes the subject matter of Example 100, the data displayed comprising a set of object nodes to represent the configuration of the cluster at the moment in time.

Example 102 includes the subject matter of Example 101, with instructions to adjust the moment in time for which configuration data is displayed based on input received via the client interface component.

Example 103 includes the subject matter of Example 99, the request for the configuration of the cluster comprising a period of time.

Example 104 includes the subject matter of Example 103, the data displayed comprising a timeline for the configuration of the cluster over the period of time.

Example 105 includes the subject matter of Example 104, with instructions to adjust the period of time displayed in the timeline based on input received via the client interface component.

Example 106 includes the subject matter of Example 104, with instructions to adjust a unit of time displayed in the timeline based on input received via the client interface component.

Example 107 includes the subject matter of Example 99, the HTT comprising an object node for each of one or more objects in the requested cluster configuration.

Example 108 includes the subject matter of Example 107, each object node comprising a common set of properties.

Example 109 includes the subject matter of Example 99, with instructions to identify the HTT in the graph database by tracing associations between nodes in the graph database.

Example 110 includes the subject matter of Example 99, the data displayed comprising a HTT.

Example 111 includes the subject matter of Example 99, the data displayed comprising a set of object nodes to represent the requested configuration of the cluster.

Example 112 includes the subject matter of Example 111, with instructions to receive a selection of an object node in the displayed set of object nodes and, in response, display a set of properties of the selected object node in the GUI.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. An apparatus, comprising:
logic, at least a portion of which is implemented in hardware, the logic comprising an event correlation application to maintain a graph database of nodes and associations regarding configurations of a cluster of one or more objects, the event correlation application comprising:
a notification interface component to receive a notification, the notification to indicate a current configuration of one or more objects in the cluster;
an indexing component to compare the current configuration of the cluster with a previous configuration of the cluster, wherein the previous configuration of the cluster is associated with a previous timestamp node in the graph database; and
a graph engine to create a current timestamp node based on the received notification and associate the current timestamp node with the previous timestamp node in the graph-database based on the comparison of the current and previous configurations of the cluster.

2. The apparatus of claim 1, the indexing component to identify a configuration change between the previous configuration and the current configuration of the cluster based on the comparison of the current configuration to the previous configuration of the cluster.

3. The apparatus of claim 2, the configuration change comprising an object present in the previous configuration of the cluster and absent from the current configuration of the cluster.

4. The apparatus of claim 2, the configuration change comprising an object present in the current configuration of the cluster and absent from the previous configuration of the cluster.

5. The apparatus of claim 4, the graph engine to create a current object node to represent the configuration change in the representational database and associate the current object node with the current timestamp node in the representational database.

6. The apparatus of claim 5, the current object node comprising one or more properties of the object present in the current configuration of the cluster and absent from the previous configuration of the cluster.

7. The apparatus of claim 1, wherein the previous configuration of the cluster is associated with a previous object node in the graph database, the previous object node to represent a configuration of an object in the cluster at a previous moment in time.

8. The apparatus of claim 7, the graph engine to associate the current timestamp node with the previous object node in the graph database.

9. The apparatus of claim 8, wherein the configuration of the object represented by the previous object node remains unchanged between the previous configuration of the cluster and the current configuration of the cluster.

10. The apparatus of claim 1, the graph database comprising one or more hierarchical time trees (HTTs).

11. The apparatus of claim 2, the configuration change comprising property change in an object present in both the current configuration and previous configuration.

12. The apparatus of claim 2, the configuration change comprising of a relationship present in the previous configuration of the cluster but absent from the current configuration of the cluster.

13. The apparatus of claim 2, the configuration change comprising of a relationship present in the current configuration of the cluster but absent from the previous configuration of the cluster

14. The apparatus of claim 2, the configuration change comprising a property change in a relationship present in the current configuration and the previous configuration.

15. A computer-implemented method, comprising:
receiving a request for a configuration of a cluster of one or more objects;
identifying and/or creating a hierarchical time tree (HTT) of nodes and associations in a graph database based on the request, the HTT including a timestamp node, an object node, and an association between the timestamp node and the object node; and
displaying data related to the requested configuration of the cluster in a graphical user interface (GUI) based on the identified HTT of nodes and associations.

16. The computer-implemented method of claim 11, the request for the configuration of the cluster including a moment in time or a relationship between configurations.

17. The computer-implemented method of claim 12, the data displayed including a set of object nodes representing the configuration of the cluster at the moment in time.

18. The computer-implemented method of claim 13, comprising adjusting the moment in time for which configuration data is displayed based on input received via the client interface component.

19. The computer-implemented method of claim 11, the request for the configuration of the cluster including a period of time.

20. The computer-implemented method of claim 15, the data displayed comprising a timeline for the configuration of the cluster over the period of time.

21. One or more computer-readable media to store instructions that when executed by a processor circuit causes the processor circuit to:
receive a notification indicating a current configuration of a cluster of one or more objects;
compare the current configuration of the cluster with a previous configuration of the cluster, the previous configuration of the cluster associated with a previous timestamp node in a graph database of nodes and associations;
create a current timestamp node in the graph database based on the received notification; and
associate the current timestamp node with the previous timestamp node in the graph database based on the comparison of the current and previous configurations of the cluster

22. The one or more computer-readable media of claim 17, with instructions to identify a configuration change between the previous configuration and the current configuration of the cluster based on the comparison of the current configuration to the previous configuration of the cluster.

23. The one or more computer-readable media of claim 18, the configuration change comprising an object or relationship present in the previous configuration of the cluster and absent from the current configuration of the cluster.

24. The one or more computer-readable media of claim 18, the configuration change comprising an object present in the current configuration of the cluster and absent from the previous configuration of the cluster.
